(19) United States
(12) Patent Application Publication
(10) Pub. No.: US 2009/0304013 A1
(43) Pub. Date: Dec. 10, 2009

(54) NETWORK TUNNELLING

(75) Inventors: James Nicholas Green, Cambridge (GB); Jonathan Edward Vernon Custance, St. Albans (GB)

Correspondence Address: Levenfeld Pearlstein, LLC;Intellectual Property Department, 2 North LaSalle, Suite 1300, Chicago, IL, 60602, US

(73) Assignee: CAMRIVOX, LTD., Cambridge (GB)

(21) Appl. No.: 12/377,569

(22) PCT Filed: Aug. 17, 2007
(86) PCT No.: PCT/GB2007/003157

§ 371 Date: Aug. 24, 2009

(30) Foreign Application Priority Data
Aug. 17, 2006 (GB) 0616467.7

(51) Int. Cl. H04L 12/56

(52) U.S. Cl. 370/401

(57) ABSTRACT

A method and apparatus for broadening of a communication channel already established between remote networks includes detection of an existing communication channel (15) established between a first local network device (7) on a first LAN (1) and a remote network device (12) on a second LAN (2) remote from the first (1), determination of one or more properties associated with that existing communication channel, establishment of a tunnel (16) between the first local network device (7) on the first LAN (1) and the remote network device (12) on the second LAN (2) based upon the one or more properties associated with the existing communication channel (15), and forwarding traffic from a second local network device (4) on the first LAN (1) via the tunnel (16) to the or a remote network device (10) on the second LAN (2).

### FIELD OF THE INVENTION

The present invention relates to transient connections between remote networks. In particular the invention relates to the broadening of a communication channel already established between the remote networks.

### BACKGROUND OF THE INVENTION

A Local Area Network (LAN) of a home or business environment comprises a plurality of network devices, such as personal computers (PCs), printers, storage devices, telephones, etc. The LAN may be connected to a Wide Area Network (WAN) via a WAN interface device, such as a broadband Digital Subscriber Line (DSL) modem.

A plurality of LANs may therefore be joined by a WAN, for example the Internet or a radio network. Connections may be established between devices on respective LANs via the WAN. Existing Internet applications enabled by such connectivity include Instant Messaging on a PC, and Voice-over Internet Protocol (VoIP) telephone calls on an Internet Protocol (IP) phone, to other users on the Internet.

To enable remote network devices at edges of LANs, so-called “end-points”, to communicate a communication channel must be established between the end-points. Communication on such a channel is strictly limited to those end-points involved. Methods are known for opening a communication channel across the Internet between end-points, for example placing a VoIP call between two IP phones. Communication “sessions” are typically initiated, modified and terminated using the Session Initiation Protocol (SIP), or other similar signalling protocol. In use, SIP sessions typically enable streams of packets using the Real-time Transport Protocol (RTP) which is the carrier for media content itself. The RTP packets used to carry the media stream often do not traverse Network Address Translation (NAT) routers and the like. As appreciated by someone knowledgeable in the art, the introduction of NAT into such a network adds extra complexity, removing the ability to easily communicate directly with an end-point using a public IP address on the Internet. Traversal of User Datagram Protocol (UDP) packets through NAT is often achieved using Simple Traversal of UDP through NAT (STUN) and/or proxies. Similar methods using proxies are used for PC Instant Messaging and peer-to-peer networking to traverse firewalls.

A difficulty associated with end-point communication across a WAN using existing methods is that it often requires a significant up-front configuration of the device or intermediate NAT router to allow the communication channel to be opened in the first place. This is usually not an insurmountable problem for a user if they have to perform the configuration only once, as in the case of setting up an IP phone, but it is too cumbersome if they have to configure each end-point on a LAN for each person with whom they want to communicate across a WAN. In the case where NAT is present at both ends of the required communication session, further inconvenience is encountered as both users must make appropriate configuration changes.

An object of the present invention is therefore to reduce the configuration required to establish transient communication between end-points across a WAN.

### SUMMARY OF THE INVENTION

According to a first aspect of the present invention, there is provided a network device module for connection on a first LAN connected to a second LAN remote from the first, the module comprising means for detecting an existing communication channel established between a first local network device on the first LAN and a remote network device on the second LAN and for determining one or more properties associated with that existing communication channel, means for establishing a tunnel between the first local network device on the first LAN and the remote network device on the second LAN based upon the one or more properties associated with the existing communication channel, and means for forwarding traffic from a second local network device on the first LAN via the tunnel to the or a remote network device on the second LAN.

The existing communication channel is a typical connection between two networked devices such that data/packets are sent bi-directionally between the devices across the network. Both devices require sufficient configuration to route the data/packets between the devices across the network.

The tunnel is a specific bi-directional connection built on top of a typical established connection, such as the communication channel above. The tunnel connects two remote devices and in effect creates a tunnel between the LANs in which those devices are situated. The tunnel makes it appear to devices on those networks that the networks are immediately adjacent and disguises the possibility that the tunnel may cross many other networks. Therefore the devices on the networks may communicate more easily. The tunnel can be arranged such that the networks are not even immediately adjacent, but appear to be on the same network, which makes communication even easier.

The present invention utilises the advantages of a tunnel to broaden the existing communication channel already established between the first local network device on the first LAN and the remote network device on the second LAN. Ordinarily, a tunnel would require significant set-up and configuration, including authentication, to be established. However, the present invention utilises one or more properties associated with the already authenticated and configured existing communication channel to establish the tunnel. No further set-up or configuration is therefore required to establish the tunnel, even where a tunnel has not been created to that particular second LAN previously. The tunnel is transient and its lifetime can be limited by setting an option to terminate the tunnel once the initial communication channel has been terminated. This simply addresses often complex security issues associated with tunnels in a manner that is easy for relatively unskilled users to understand.

Since traffic from the secondary local network device(s) is forwarded via the tunnel to the remote network, the secondary local network device(s) may have static local configuration settings even though the tunnel is dynamic, or transient. The present invention is therefore particularly advantageous in that the settings for local devices on the first LAN do not need to be changed regardless of whom the tunnel happens to be with at that particular time. This is made possible since each secondary local network device is unaware that it is communicating with a remote device and does not need to run any dedicated software to enable the connection. The present invention therefore removes the problems of the prior art of having to configure each secondary network device not involved in the original communication channel before they can communicate with the remote network.

The network device module may be implemented in the first local network device, which may be, for example, a VoIP telephone, a PC, a router, a cable modem, a DSL modem, an Integrated Access Device (IAD), a Set-Top Box (STB), a mobile telephone, or IP networked device. Since the network device module can be easily implemented on many different types of network devices, including routers, the invention has broad applicability.

The network device module may further include means for forwarding to the second local network device on the first LAN traffic originating from a remote network device on the second LAN. The traffic originating from the remote network device is sent via the tunnel by another network device module of the invention implemented on the second LAN side. The remote network device having the other network device module may be the remote network device involved in the original communication channel or another networked device on the second LAN side.

Preferably, the network device module further includes means for readdressing the traffic between the second local network device and the remote network device before forwarding. This readdressing is preferably a NAT implementation, which may readdress the source and destination addresses of the traffic.

The network device module may include means for storing information and/or rules relating to the tunnel and/or its traffic. The information may relate to security considerations of the network connections.

The second local network device may be, for example, a PC, a VoIP telephone, a computer games console, a printer, a STB, or IP networked device.

To authorise the tunnel and provide additional security measures, the tunnel is established in response to a user input, for example, a user depressing a button or the like.

Whilst the first aspect of the present invention is directed to the network device module per se, the second aspect of the present invention provides a system comprising a first LAN connected to a second LAN remote from the first, the first LAN including a first network device module, a first local network device, and a second local network device; and the second LAN including a second network device module, a first remote network device, and a second remote network device, wherein at least one of the first and second network device modules comprises means for detecting an existing communication channel established between the first local network device and the first remote network device and for determining one or more properties associated with that existing communication channel, and means for establishing a tunnel between the first local network device on the first LAN and the first remote network device on the second LAN based upon the one or more properties associated with the existing communication channel; and wherein the first network device module further comprises means for forwarding traffic from the second local network device via the tunnel to the first remote network device, and the second network device module further comprises means for forwarding traffic from the second remote network device via the tunnel to the first local network device.

The second aspect of the present invention therefore illustrates how the communication between two devices on different LANs may be broadened on both LAN sides. The preferred features of the present invention in accordance with the second aspect are substantially the same as for the first aspect, mirrored for each of the first and second network device modules.

The present invention also provides, in accordance with a third aspect, a method for extending network access comprising the steps of detecting an existing communication channel established between a first local network device on a first LAN and a remote network device on a second LAN remote from the first, determining one or more properties associated with that existing communication channel, establishing a tunnel between the first local network device on the first LAN and the remote network device on the second LAN based upon the one or more properties associated with the existing communication channel, and forwarding traffic from a second local network device on the first LAN via the tunnel to the or a remote network device on the second LAN.

The method may further comprise the steps of: forwarding traffic to the second local network device on the first LAN originating from the remote network device on the second LAN sent via the tunnel; readdressing the traffic between the second local network device and the remote network device before forwarding; and storing information and/or rules relating to the tunnel and/or its traffic.

There is also provided in a fourth aspect of the present invention a method for extending network access comprising the steps of detecting an existing communication channel established between a first local network device on a first LAN and a first remote network device on a second LAN remote from the first, determining one or more properties associated with that existing communication channel, establishing a tunnel between the first local network device on the first LAN and the remote network device on the second LAN based upon the one or more properties associated with the existing communication channel, forwarding traffic from a second local network device on the first LAN via the tunnel to the first remote network device on the second LAN, and forwarding traffic from the second remote network device via the tunnel to the second local network device.

The method of the fourth aspect may further comprise the steps of forwarding traffic to the second local network device originating from the second remote network device sent via the tunnel; forwarding traffic to the second remote network device originating from the second local network device sent via the tunnel; readdressing the traffic between the second local network device and the first remote network device before forwarding; readdressing the traffic between the second remote network device and the first local network device before forwarding; and storing information and/or rules relating to the tunnel and/or its traffic.

### BRIEF DESCRIPTION OF THE DRAWINGS

Examples of the present invention will now be described in more detail with reference to the accompanying drawings, in which:

FIG. 1 shows a schematic diagram of a typical network;

FIG. 2 shows a schematic diagram of communication paths across a typical network in accordance with the present invention;

FIG. 3 shows a schematic diagram of a comparative double-ended NAT configuration; and

FIG. 4 shows an example software architecture of the network device module.

### DETAILED DESCRIPTION

The present invention will now be described as implemented on an IP phone but it is to be understood that the invention could be implemented in a very similar manner on PCs, WiFi mobile phones, or virtually any networked communication device.

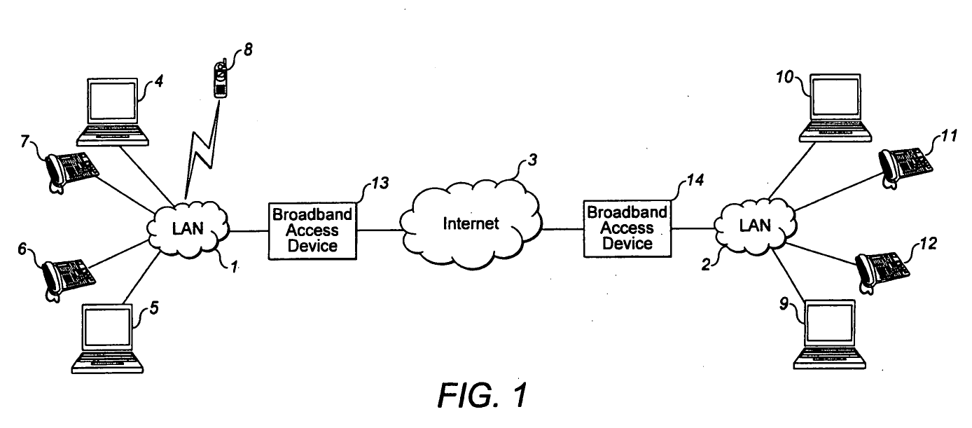

FIG. 1 illustrates a typical network comprising a first LAN 1 and a second LAN 2 joined by the Internet 3. PCs 4,5, IP phones 6,7 and Wi-Fi mobile phone 8 are connected to LAN 1 and PCs 9,10 and IP phones 11,12 are connected to LAN 2. LANs 1,2 are joined to the Internet 3 via respective broadband access devices 13,14. Printers, external storage devices, games peripherals and the like may be connected to the PCs 4,5,9,10, or directly to the LANs 1,2.

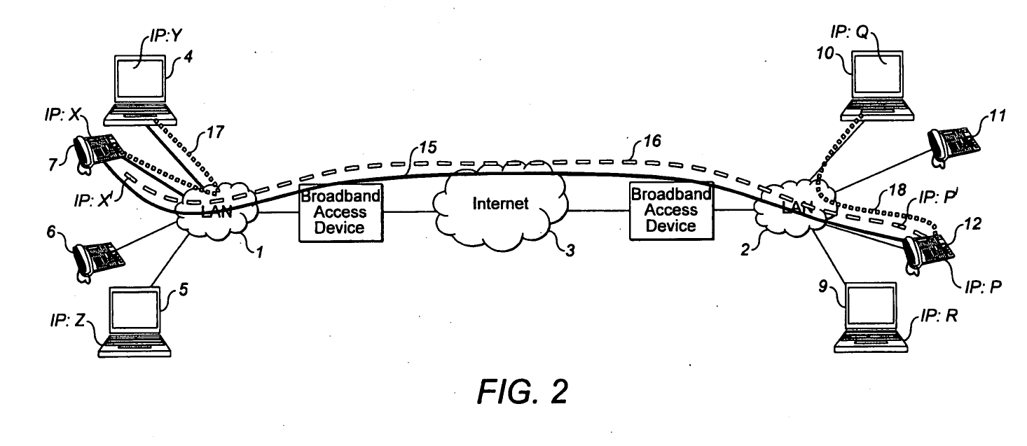

First a communication channel is established between two devices. In this exemplary embodiment of the present invention the communication channel is established between two IP phones. IP phone 7 is located on LAN 1 and has private IP address X, and IP phone 12 is located on LAN 2 and has private IP address P. The audio data for the phone call would typically be in an RTP data stream established by a signalling protocol such as SIP. The full line 15 shown in FIG. 2 shows this RTP communication channel.

If, during the phone call, one of the users involved in the call decides that they wish to share another networked device or application with the far-end user, that is the other user in the call whose IP phone is located on the LAN remote from the proposed sharer, then a second communication channel is established by the proposed sharer's IP phone. The second communication channel is created between IP phone 7 on LAN 1 and IP phone 12 on LAN 2. It is bidirectional and can be used to forward whole network packets from one LAN to the other and vice-versa, in effect creating a tunnel via the two LANs of the IP phones involved in the call.

Tunnel Establishment

This section describes how the existing communication channel, such as the phone call using IP phones 7 and 12, is used to help establish the second communication channel between the two parties, for use by other applications, such as a shared whiteboard. The second communication channel is a tunnel between the LANs of the two parties.

One or more properties of the existing communication channel are utilised in the creation of the tunnel. These properties may be authentication or data for establishment of the tunnel. Authentication can be achieved by the fact that the two users involved in the initial phone call can talk to verify each is trusted by the other. If either is unhappy, they can instruct their IP phone, 7 or 12, not to proceed and prevent the creation of the tunnel. Also, the existing communication channel can be used by the IP phones 7,12 to exchange data enabling the establishment of the tunnel. Use of this data to establish the tunnel will be described in greater detail in the section “Packet Transfer Through the Tunnel” below.

Dependent upon the nature of the telephony technology used for the existing communication channel, data is exchanged by the two parties in different ways:

(a) If both parties are on the same VoIP network, then data is exchanged by sending information using native signalling messages, for example SIP INFO messages. This is the easiest and preferred method.

(b) If the parties are both using VoIP, but separated by a proxy then signalling messages may not travel end-to-end. Nevertheless an end-to-end digital communication channel will likely exist, for example RTP voice data. Specially coded RTP packets can be transferred to communicate messages.

(c) Finally, it may be the case that the two parties have no digital connection between them at all, for example if a Public Switched Telephone Network (PSTN) gateway is involved in the call. In this situation data can still be exchanged between the two parties, but modem or Frequency Shift Keying (FSK) tones would have to be used. This is the least desirable method as audio disruption would occur in the phone call, albeit briefly.

The devices employing the present invention need to analyse the existing communication channel in order to determine which technique listed above is to be used to exchange messages. One approach is to try a ping-style message using each method in turn until one succeeds. In this case the methods should be tried in order of preference (a), (b), and then (c).

Given the above, short messages can be exchanged by the two parties. These messages are used to establish the tunnel.

Packet Transfer Through the Tunnel

Persons knowledgeable in the art will know that a number of methods can be used for transferring packets to form a tunnel between the IP phones.

Firstly, in a similar way to SIP/RTP, the use of STUN and/or a proxy to traverse devices such as NAT routers could be implemented, allowing a UDP connection between the IP Phones. Then a protocol such as Point-to-Point Protocol (PPP) could be layered on top of the UDP connection to provide a more powerful connection.

Secondly, on PCs instant messaging effectively achieves a tunnel by use of a proxy on the Internet that all parties can access.

Thirdly, peer to peer networking also achieves the same end result by a similar method to instant messaging.

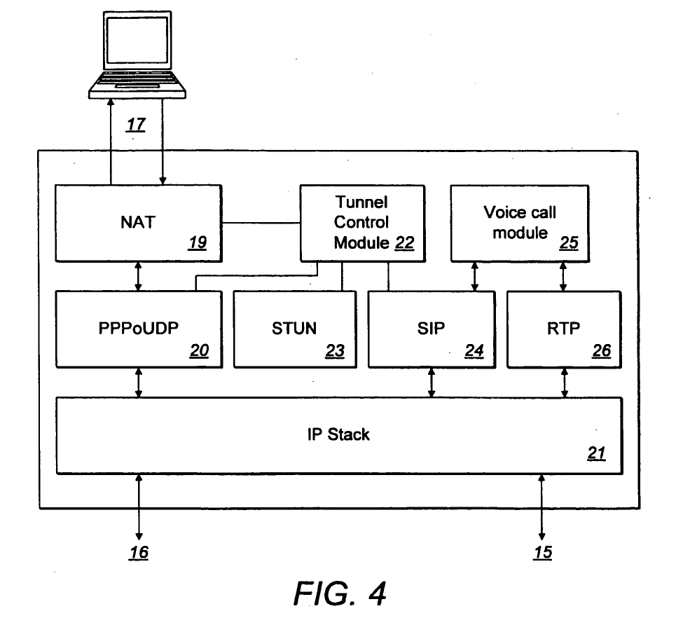

IP phones will typically already have a STUN implementation, so it makes sense to use the first method noted above. With reference to FIG. 2 and FIG. 4, this method is now described. First, both IP phones 7,12 establish a UDP connection on to the Internet 3, through any NAT routers between themselves and the Internet 3. Next, both IP phones 7,12 use a public STUN server to find the public port and IP address of their UDP connection when it reaches the Internet 3. Then, the IP phones 7,12 exchange details of their public port and IP address to their opposite number, using the simple message exchange mechanism described in the Tunnel Establishment section above. Now the two IP phones 7,12 each have details of how to send UDP packets to their opposite number. Finally they can run a standard PPP stack on top of this UDP connection.

IP Address Translation for the Tunnel

Now that a tunnel has been established and it is capable of transferring IP packets, all that remains is the translation of IP addresses and ports between the two LANs.

Turning again to FIG. 2 there is shown an example in which, during the phone call using IP phones 7 and 12, user of IP phone 7, who is running, for example, a whiteboard application on PC 4, wishes to share the whiteboard application with the user of IP phone 12 running an equivalent whiteboard application on PC 10. To initiate sharing of the application, PC 4 wants to send network traffic to PC 10.

A packet to initiate the application sharing is sent from PC 4 having private IP address Y to IP phone 7 having private IP address X via local connections 17. The packet header includes IP address Y as the source IP address, IP address X as the destination IP address, and whiteboard as the destination network port. IP phone 7 receives the packet and establishes a tunnel to IP phone 12. Alternatively, the tunnel may be established by the user of IP phone 7 pressing a button on the IP phone, or a similar such mechanism, prior to sending the packet from PC 4. Various methods for creating the tunnel are known and these will be described in more detail in the following. The tunnel, a second communication channel in addition to the original SIP and RTP streams, is shown in FIG. 2 by the dashed line 16.

During establishment of the tunnel the IP phones 7 and 12 can allocate each other non-conflicting private IP addresses for each end of the tunnel on their respective LANs, for example X′ and P′, as shown in FIG. 2.

Having established the tunnel, IP phone 7 prepares to forward the packet down the tunnel to the far-end. The IP phone 7 must perform IP address translation on the packet to be forwarded to convert between the private IP addresses used on the LANs 1,2. This can be achieved by using a standard NAT implementation. This packet is the first of the new shared whiteboard session so the NAT implementation takes note of certain details such as the source IP address (in this case Y, the IP address of PC 4), details of the tunnel to be used (in this case the tunnel 16 to IP phone 12), and protocol port information (in this case the whiteboard application) to help with directing any return traffic.

The packet header is translated accordingly and NAT Application Level Gateways (NAT ALGs) are used as necessary to prevent protocol corruption. Both the source and destination IP addresses undergo translation. The source IP address of the packet is set to the IP address of IP phone 7, on the tunnel 16, IP address X′. The destination IP address is set to the IP address of IP phone 12, on the tunnel 16, IP address P′. The destination port designation in the packet header remains as before, whiteboard. IP phone 7 then forwards the packet down the tunnel 16 to the far-end.

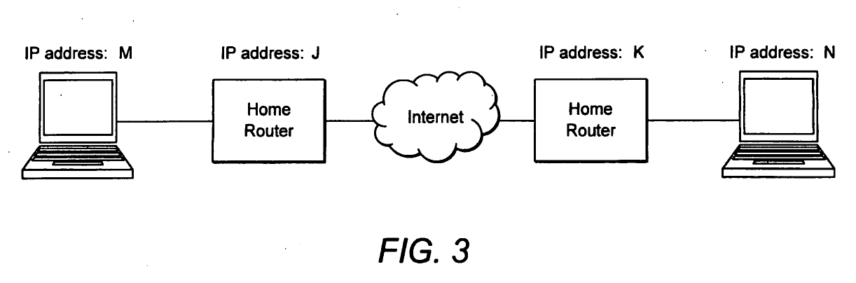

The tunnel 16 has NAT at both ends forming a double-ended NAT scenario. In concept this scenario is similar to the way home routers are deployed using the Internet. The home routers run NAT and use the Internet as a tunnel. FIG. 3 illustrates as a comparative example how PCs and home routers could be connected in a double-ended NAT configuration. The PC having private IP address M would use public IP address K to access the PC having private IP address N. The PC having private IP address N would use public IP address J to access the PC having private IP address M.

The IP phones 7,12 of the FIG. 2 embodiment of the present invention are analogous to the home routers in FIG. 3. The key difference between the NAT scenarios of FIGS. 2 and 3 is that in FIG. 2 PC 4 uses the local IP address of IP phone 7, private IP address X, to access the far-end PC 10. Similarly, PC 10 uses the local IP address of IP phone 12, private IP address X, to access the far-end PC 4. This is the only difference in understanding the NAT aspects of the two scenarios and requires in practice an extra NAT step to be performed by the IP phones. This is the step of translating the source and destination IP addresses performed on the packet header by the IP phones 7,12 as described above.

Returning to the shared whiteboard example, after the packet has been sent through the tunnel 16 it arrives at the far-end IP phone 12. IP phone 12 applies predetermined NAT rules to the received packet. The IP phones 7,12 need to be configured with such rules to dictate default behaviour for packets forwarded from the tunnel 16 to their respective LANs 1,2. These rules effectively associate, or pair, the IP phones 7,12 with other networked devices on their LAN side. In this shared whiteboard example the configuration, or rules, indicate to the IP phones 7,12 which PCs, PCs 4,10, should be used for packets pertaining to the shared whiteboard applications.

The rules apply to incoming packets received from the tunnel 16. These rules dictate to the IP phones 7,12 what to do with the received packets, and which device on their respective LANs 1,2 to forward them on to. The rules for deciding which address to use in the translation can be based on a number of inputs. For example, fields from inside the packet can be used, such as a destination port. This is similar to the way home routers can be used to statically route HyperText Transfer Protocol (HTTP) packets to a home PC running as a public web server. Alternatively, protocols such as Universal Plug and Play (UPnP) can automatically inform and configure the IP phones 7,12 making them aware of the PC or device to be used for specified applications.

Since the packet arriving at the far-end IP phone 12 is a first packet for a new session, the NAT implementation records information on the session such as the tunnel the packet was received on, in this case tunnel 16, and protocol port information to help direct any return traffic. The NAT rules will determine that this packet should be forwarded to PC 10 via local connections 18 based on the destination port designation of the packet header, in this case the whiteboard.

The IP phone 12 translates the IP addresses in the packet header and applies any necessary NAT ALGs to the packet in order to prevent protocol corruption. Both the source and destination IP addresses undergo NAT. The source IP address of the packet is set to the IP address of IP phone 12, IP address P. The destination IP address is set to the IP address of PC 10, IP address R. The destination port designation in the packet header remains as before, whiteboard. IP phone 12 then forwards the packet to the PC 10.

PC 10 receives the packet and the shared whiteboard application processes the packet. From the perspective of the PC 10 the packet received has come from the IP phone 12 since the packet header includes IP address P as the source IP address. Accordingly, the PC 10 uses IP address P for replies. Due to the double-ended NAT implementation at the ends of the tunnel 16, PCs 4 and 10 believe they are communicating using the IP address of their local IP phones, 7 and 12, respectively. In reality the packets are destined for a device on the remote network. Continuing this shared whiteboard example further, next will be described a reply from PC 10 back to PC 4. PC 10 sends shared whiteboard traffic back to the far-end using IP phone 12. In the packet sent from PC 10 via local connections 18 the packet header includes IP address R as the source IP address, IP address P as the destination IP address, and whiteboard as the destination port. IP phone 12 receives this packet and using information that it has stored (for example, the whiteboard port and session information) determines that the packet corresponds to an existing session. Details of the session are retrieved and a keep-alive timer for the session will be updated.

Prior to sending the packet down the tunnel 16, the IP addresses of the packet header are translated by the NAT implementation. NAT ALGs are used as necessary to prevent protocol corruption. Both the source and destination IP addresses undergo NAT. The source IP address of the packet is set to the IP address of IP phone 12, on the tunnel 16, IP address P′. The destination IP address is set to the IP address of IP phone 7, on the tunnel 16, IP address X′. The destination port designation in the packet header remains as before, whiteboard. IP phone 12 then forwards the packet down the tunnel 16 to the far-end IP phone 7.

The IP phone 7 applies its NAT rules to the received packet. The packet will match details already noted by the NAT implementation when the original outbound traffic was forwarded. In particular the match will include the tunnel used and session information. Since the packet matches an existing session, the session details will indicate the location IP address Y of PC 4 that should be used for forwarding the packet.

IP phone 7 translates addresses in the packet header, and applies any necessary NAT ALGs to the packet in order to prevent protocol corruption. The source IP address of the packet is set to the IP address of IP phone 7,X. The destination IP address is set to the IP address of PC 4,Y. The destination port designation in the packet header remains as before, whiteboard.

PC 4 receives the packet via local connections 17 and the shared whiteboard application processes the packet. From the perspective of the PC 4 the packet received has come from the IP phone 7 since the packet header includes IP address X as the source IP address. Accordingly, the PC 4 uses IP address X for replies.

The present invention therefore extends access achieved by the communication channel 15 established for the IP phone call between the IP phones 7,12 to the networked PCs 4,10. In so doing, the invention removes the configuration and set-up that the PCs 4,10 would otherwise need in order to communicate with one other remotely, and no special software is required on PCs 4,10. Only the IP phones 7,12 contain extra software in this implementation of the present invention. In fact, the PCs 4,10 are unaware that they are communicating with a device on a remote network.

Replies from PC 4 to PC 10 are handled similarly and so subsequent packets can be transmitted bi-directionally. As with any standard NAT implementation, the IP phones 7,12 must maintain steady state internally to keep track of devices using the tunnel 16. For example, they must track Transmission Control Protocol (TCP) sessions. The keep-alive timer is maintained by each IP phone 7,12 during the session each time a packet is forwarded.

If at any time a packet is detected that does not match an existing session then the IP phone 7,12 on the LAN side originating the packet recognises it as the first packet of a new session and repeats the steps for initiating a new session as set out above accordingly.

If at any time the NAT rules implemented by the IP phones 7,12 do not match packet requirements then the packet may be dropped to avoid certain security issues. Alternatively, configuration and security confirmation may be requested of the user to update the NAT rules if appropriate.

The above exemplary shared whiteboard implementation is to be seen as in no way limiting on the present invention which is defined by the claims and many further end-user applications are envisaged within the scope of the present invention. For example, on-demand sharing of other PC applications, transfer of files to a PC of a far-end caller, remote printing, remote debugging by a system administrator, remote access of home PCs, Set-Top-Boxes (STBs) and files, synchronisation of consumer networked devices, and connecting of games consoles and similar devices are some of many potential applications.

It should be noted that whilst the exemplary embodiment described above with reference to FIG. 2 illustrates the communication channel 15 and the tunnel 16 as taking direct routes across the Internet 3, the present invention applies equally to communication mechanisms that use a proxy on the internet, such as instant messaging and peer-to-peer networking.

It should also be pointed out that it could be desirable to utilize communication through the tunnel without using NAT at each end. It is only possible to achieve this if the two PCs that wish to communicate do not share the same IP address and are not part of a LAN where another device or PC on the LAN has the same IP address as the PC at the far end of the tunnel.

If these conditions are met then it is possible to enable the PCs/devices that wish to communicate through the tunnel to make their IP address known to the remote network device (containing the network device module of the invention) at the far end of the tunnel. It also becomes possible to adjust a routing table on the PCs that wish to communicate, to use their local network device (containing the network device module of the invention) as the first stage of the traffic path for packets destined to the IP address of the remote PC. In this way, the PCs would then need to communicate directly using their actual IP addresses.

The routing table could be adjusted by an Internet Control Message Protocol (ICMP) Redirect, since an ICMP packet can be sent to a PC or device to adjust its routing table, or by an application running on a PC which could communicate with the tunnel to understand how the routing table should be changed.

To simplify matters for the end user, a PC application could also be used to help exchange the details of the PCs at either end that wish to communicate.

Software Architecture

FIG. 4 illustrates an exemplary software architecture of the stack to handle the tunnel. In this example the architecture resides in the IP phone. The arrows shown correspond to data paths between the various entities.

Prior to establishment of the tunnel, the VoIP phone call will be in progress. The call is managed by the Voice call module 25, which in turn uses the SIP 24, RTP 26, and IP stack 21 modules to facilitate the call.

At the user's discretion the tunnel can be created. The tunnel is managed by the Tunnel Control Module 22. The Tunnel Control Module can interrogate SIP 24 to determine that a call is in progress; this is a prerequisite for creating the tunnel. Furthermore, SIP can aid tunnel establishment by conveying messages to the far-end party (using a mechanism such a SIP Notify message).

At each end of the tunnel, the Tunnel Control Module uses the STUN module 23 to open a public UDP connection on the WAN/Internet. The Tunnel Control Module conveys details of this UDP connection to the far-end using a SIP Notify message as previously mentioned, or an equivalent mechanism.

Now that both parties know a public UDP port for contacting their counterpart, they are able to create a bidirectional tunnel. The NAT 19, PPPoUDP 20, and IP Stack 21 modules are layered on top of each other to create the tunnel for PC 17. The Tunnel Control Module performs any necessary coordination.

1. A network device module for connection on a first Local Area Network (LAN) connected to a second LAN remote from the first, the module comprising:
means for detecting an operating communication channel established between a first local network device on the first LAN and a remote network device on the second LAN and for determining one or more properties associated with that operating communication channel;
means for establishing, in addition to the communication channel, a tunnel between the first local network device on the first LAN and the remote network device on the second LAN based upon the one or more properties associated with the operating communication channel; and
means for forwarding traffic from a second local network device on the first LAN via the tunnel to the or a remote network device on the second LAN.

2. A network device module according to claim 1, implemented in the first local network device.

3. A network device module according to claim 1, further comprising means for forwarding traffic to the second local network device on the first LAN originating from the remote network device on the second LAN sent via the tunnel.

4. A network device module according to claim 1, further comprising means for readdressing the traffic between the second local network device and the remote network device before forwarding.

5. A network device module according to claim 4, wherein the readdressing means is a Network Address Translation (NAT) implementation.

6. A network device module according to claim 4, wherein the source and destination addresses of the traffic are readdressed.

7. A network device module according to claim 1, further comprising means for storing information and/or rules relating to the tunnel and/or its traffic.

8. A network device module according to claim 1, wherein the first local network device is a local network device selected from the group comprising a Voice over Internet Protocol (VoIP) telephone, a Personal Computer (PC), a router, a cable modem, a Digital Subscriber Line (DSL) modem, an Integrated Access Device (IAD), a Set-Top Box (STB), a mobile telephone, or Internet Protocol (IP) networked device.

9. A network device module according to claim 1, wherein the second local network device is a local network device selected from the group comprising a PC, a VoIP telephone, a computer games console, a printer, a STB, or IP networked device.

10. A network device module according to claim 1, wherein the tunnel is established in response to a user input.

11. A method for extending network access comprising the steps of:
detecting an operating communication channel established between a first local network device on a first Local Area Network (LAN) and a remote network device on a second LAN remote from the first;
determining one or more properties associated with that operating communication channel;
establishing, in addition to the communication channel, a tunnel between the first local network device on the first LAN and the remote network device on the second LAN based upon the one or more properties associated with the operating communication channel; and
forwarding traffic from a second local network device on the first LAN via the tunnel to the or a remote network device on the second LAN.

12. A method according to claim 11, further comprising the step of forwarding traffic to the second local network device on the first LAN originating from the remote network device on the second LAN sent via the tunnel.

13. A method according to claim 11, further comprising the step of readdressing the traffic between the second local network device and the remote network device before forwarding.

14. A method according to claim 11, further comprising the step of storing information and/or rules relating to the tunnel and/or its traffic.

15. A system comprising:
a first Local Area Network (LAN) connected to a second LAN remote from the first, the first LAN including:
a first network device module;
a first local network device; and
a second local network device, and
the second LAN including:
a second network device module;
a first remote network device; and
a second remote network device,
wherein at least one of the first and second network device modules comprises:
means for detecting an operating communication channel established between the first local network device and the first remote network device and for determining one or more properties associated with that operating communication channel; and
means for establishing, in addition to the communication channel, a tunnel between the first local network device on the first LAN and the first remote network device on the second LAN based upon the one or more properties associated with the operating communication channel, and
wherein the first network device module further comprises means for forwarding traffic from the second local network device via the tunnel to the first remote network device, and the second network device module further comprises means for forwarding traffic from the second remote network device via the tunnel to the first local network device.

16. A system according to claim 15, wherein the first network device module further comprises means for forwarding traffic to the second local network device originating from the second remote network device sent via the tunnel.

17. A system according to claim 15, wherein the second network device module further comprises means for forwarding traffic to the second remote network device originating from the second local network device sent via the tunnel.

18. A system according to claim 15, wherein the first network device module is implemented in the first local network device.

19. A system according to claim 15, wherein the second network device module is implemented in the first remote network device.

20. A system according to claim 15, wherein the first and/or second network device modules further comprise means for readdressing the traffic between the second local network device and the second remote network device before forwarding.

21. A system according to claim 20, wherein the readdressing means is a Network Address Translation (NAT) implementation.

22. A system according to claim 20, wherein the source and destination addresses of the traffic are readdressed.

23. A system according to claim 15, wherein the first and/or second network device modules further comprise means for storing information and/or rules relating to the tunnel and/or its traffic.

24. A system according to claim 15, wherein the first local and/or remote network devices are a network device selected from the group comprising a Voice over Internet Protocol (VoIP) telephone, a Personal Computer (PC), a router, a cable modem, a Digital Subscriber Line (DSL) modem, an Integrated Access Device (IAD), a Set-Top Box (STB), a mobile telephone, or Internet Protocol (IP) networked device.

25. A system according to claim 15, wherein the second local and/or remote network devices are a network device selected from the group comprising a PC, a VoIP telephone, a computer games console, a printer, a STB, or IP networked device.

26. A system according to claim 15, wherein the tunnel is established in response to a user input.

27. A method for extending network access comprising the steps of:
detecting an operating communication channel established between a first local network device on a first Local Area Network (LAN) and a first remote network device on a second LAN remote from the first;
determining one or more properties associated with that operating communication channel;
establishing, in addition to the communication channel, a tunnel between the first local network device on the first LAN and the first remote network device on the second LAN based upon the one or more properties associated with the operating communication channel;
forwarding traffic from a second local network device on the first LAN via the tunnel to the first remote network device on the second LAN; and
forwarding traffic from a second remote network device on the second LAN via the tunnel to the first local network device on the first LAN.

28. A method according to claim 27, further comprising the step of forwarding traffic to the second local network device originating from the second remote network device sent via the tunnel.

29. A method according to claim 27, further comprising the step of forwarding traffic to the second remote network device originating from the second local network device sent via the tunnel.

30. A method according to claim 27, further comprising the step of readdressing the traffic between the second local network device and the first remote network device before forwarding.

31. A method according to claim 27, further comprising the step of readdressing the traffic between the second remote network device and the first local network device before forwarding.

32. A method according to claim 27, comprising the step of storing information and/or rules relating to the tunnel and/or its traffic.
